(19) United States
(12) Patent Application Publication
(10) Pub. No.: US 2010/0066268 A1
(43) Pub. Date: Mar. 18, 2010

(54) LED Light Source Module and Constant-Current Unit Structure for Use Therewith

(75) Inventor: Chih-Yang Chang, Pingzhen City (TW)

Correspondence Address: Juan Carlos A. Marquez;c/o Stites & Harbison PLLC, 1199 North Fairfax Street, Suite 900, Alexandria, VA, 22314-1437, US

(73) Assignee: Rui Teng Opto Technology Co., Ltd., Pingzhen City (TW)

(21) Appl. No.: 12/421,460

(22) Filed: Apr. 9, 2009

(30) Foreign Application Priority Data
Sep. 12, 2008 (TW) 097216582

(51) Int. Cl. H05B 41/36

(52) U.S. Cl. 315/294; 315/291

(57) ABSTRACT

An LED light source module and a constant-current unit structure for use therewith are provided. The LED light source module includes a constant-current unit and an LED set. The constant-current unit includes a voltage stabilizing unit and a resistor. The resistor is parallel-connected between two output ends of the voltage stabilizing unit. An input end of the constant-current unit receives DC voltage, and one of the output ends of the constant-current unit outputs constant current. The LED set is electrically connected to the output end of the constant-current unit to receive constant current therefrom so as for the LED set to be powered-on. Regardless of fluctuation in the DC voltage received, the constant-current unit outputs stable constant current, and the LED set emits light steadily, thereby protecting the LED set against overcurrent-induced damage.

### BACKGROUND OF THE INVENTION

1. Technical Field

The present invention relates to LED light source modules and constant-current unit structures for use therewith, and more particularly, to an LED light source module applicable to an LED lamp and a constant-current unit structure for use with the LED light source module.

2. Description of Related Art

FIG. 1 is a circuit of a conventional LED light source module 10. As shown in the drawing, the conventional LED light source module 10 comprises a plurality of light-emitting units 11 each connected to a DC voltage source 12 in parallel. Each of the light-emitting units 11 comprises a resistor 111 and a plurality of LEDs 112. The LEDs 112 and the resistor 111 are connected in series such that a DC voltage from the DC voltage source 12 is applied to the LEDs 112. Hence, the LEDs 112 are powered-on and capable of light emission.

Referring to FIG. 1, in case of stable voltage from the DC voltage source 12, the resistor 111 series-connected to the LEDs 112 controls the magnitude of current entering the LEDs 112. The LEDs 112 emit light steadily when driven by constant current under the control of the resistor 111.

However, slight fluctuation in voltage from the DC voltage source 12 causes great variation in current entering the light-emitting units 11. The unstable current has a destabilizing effect on the luminance of light emitted by the LEDs 112 of the light-emitting units 11. In addition to fluctuation in luminance of light emitted, the LEDs 112 are likely to be disadvantaged by generating heat unsteadily and thereby ending up with a short service life.

### SUMMARY OF THE INVENTION

The present invention provides an LED light source module and a constant-current unit structure for use therewith to stabilize light emitted by LEDs as the constant-current unit outputs constant current steadily despite slight fluctuation in input voltage.

The present invention provides an LED light source module and a constant-current unit structure for use therewith to protect LEDs against overcurrent-induced damage as the constant-current unit keeps output current within a range of safe current levels tolerable by LEDs.

The present invention provides an LED light source module and a constant-current unit structure for use therewith so as to output constant current with a resistor parallel-connected between output ends of a voltage stabilizing unit.

To achieve the above and other effects, the present invention provides an LED light source module, comprising: a constant-current unit, comprising: a voltage stabilizing unit having an input end, a first output end, and a second output end, the input end receiving a DC voltage, and the first output end outputting a constant current; and a resistor parallel-connected between the first output end and the second output end; and an LED set electrically connected to the first output end.

To achieve the above and other effects, the present invention provides a constant-current unit structure for use with an LED light source module, comprising: a constant-current unit comprising a voltage stabilizing unit having an input end, a first output end, and a second output end, the input end receiving a DC voltage, and the first output end outputting a constant current; and a resistor parallel-connected between the first output end and the second output end.

Implementation of the present invention at least achieves the following effects that involve an inventive step:

1. Stabilizing light emitted by an LED set with a constant-current unit;

2. Protecting the LED set against overcurrent-induced damage with the constant-current unit capable of outputting stable current;

3. Preventing current entering the LED set from varying with slight fluctuation in DC voltage, using the constant-current unit; and

4. Outputting constant current with a resistor parallel-connected between two output ends of a voltage stabilizing unit.

### BRIEF DESCRIPTION OF THE DRAWINGS

The invention as well as a preferred mode of use, further objectives, and advantages thereof will be best understood by reference to the following detailed description of illustrative embodiments when read in conjunction with the accompanying drawings, wherein:

FIG. 1 is a circuit of a conventional LED light source module;

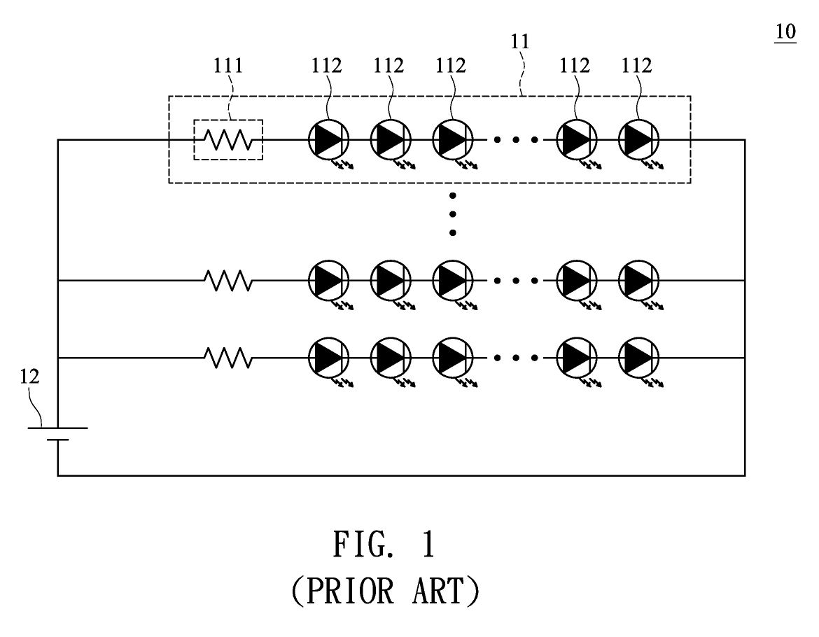

FIG. 2 is a circuit of a first preferred embodiment of an LED light source module of the present invention;

FIG. 3 is a circuit of a second preferred embodiment of an LED light source module of the present invention;

FIG. 4 is a circuit of a third preferred embodiment of an LED light source module of the present invention; and

FIG. 5 is a circuit of a fourth preferred embodiment of an LED light source module of the present invention.

### DETAILED DESCRIPTION OF THE PREFERRED EMBODIMENTS

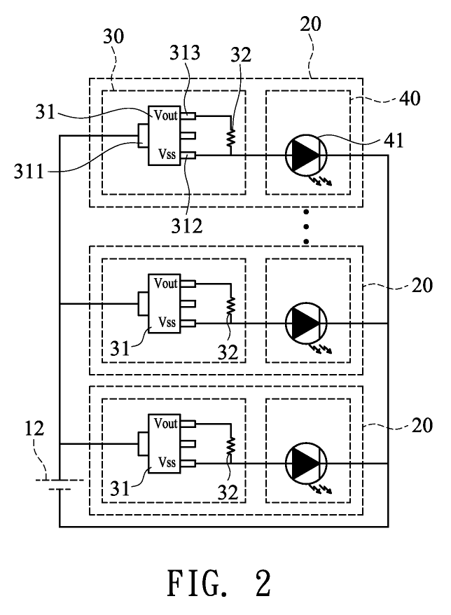

Referring to FIG. 2, in a preferred embodiment, an LED light source module 20 comprises a constant-current unit 30 and an LED set 40.

The constant-current unit 30 comprises a voltage stabilizing unit 31 and a resistor 32.

The voltage stabilizing unit 31 is an integrated circuit (IC) configured for power management and adapted to output stable voltage. The voltage stabilizing unit 31 has an input end 311, a first output end 312, and a second output end 313. The input end 311 receives a DC voltage. Regardless of fluctuation in the DC voltage received, the voltage stabilizing unit 31 outputs stable voltage. The first output end 312 of the voltage stabilizing unit 31 is a negative source voltage end (Vss). The second output end 313 of the voltage stabilizing unit 31 is a positive source voltage end (Vout).

The resistor 32 is parallel-connected between the first output end 312 and the second output end 313 of the voltage stabilizing unit 31. With the voltage stabilizing unit 31 being capable of outputting stable voltage, the voltage across the first output end 312 and the second output end 313 is converted into a constant current in the presence of the resistor 32 of a selectively appropriate resistance level, and then the constant current is output by the first output end 312.

The LED set 40 is electrically connected to the first output end 312 of the constant-current unit 30 and adapted to receive constant current from the constant-current unit 30. During operation of the LED light source module 20, regardless of fluctuation in the DC voltage applied to the constant-current unit 30, for example, the applied DC voltage rated at 24V inching toward 22V or 26V, the constant-current unit 30 outputs constant current to the LED set 40 and thereby allows the LED set 40 to emit light steadily and enjoy a prolonged service life.

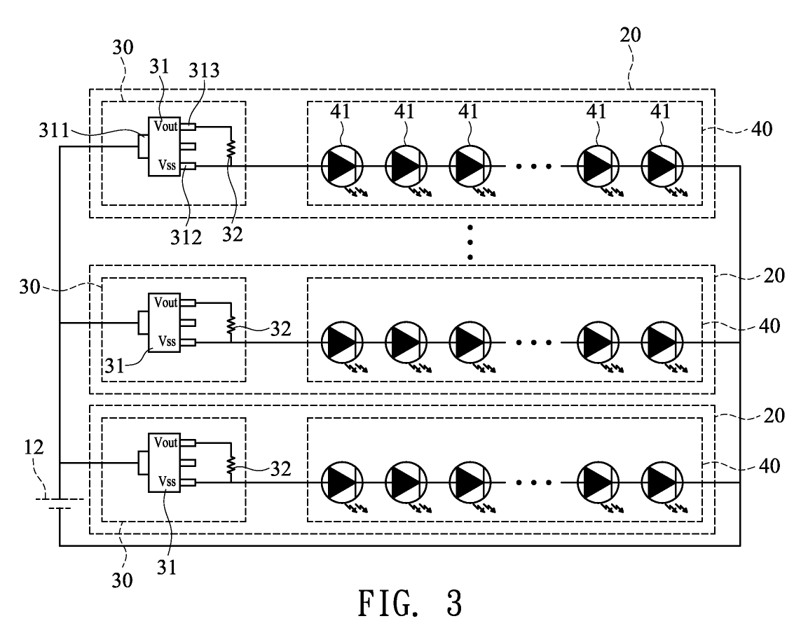

Referring to FIG. 2 and FIG. 3, the LED set 40 comprises a single LED 41 (as shown in FIG. 2) or a plurality of LEDs 41 (as shown in FIG. 3) as needed. In the latter aspect, the LEDs 41 are connected to one another in series, so as to further enhance the luminance of light emitted by the LED set 40.

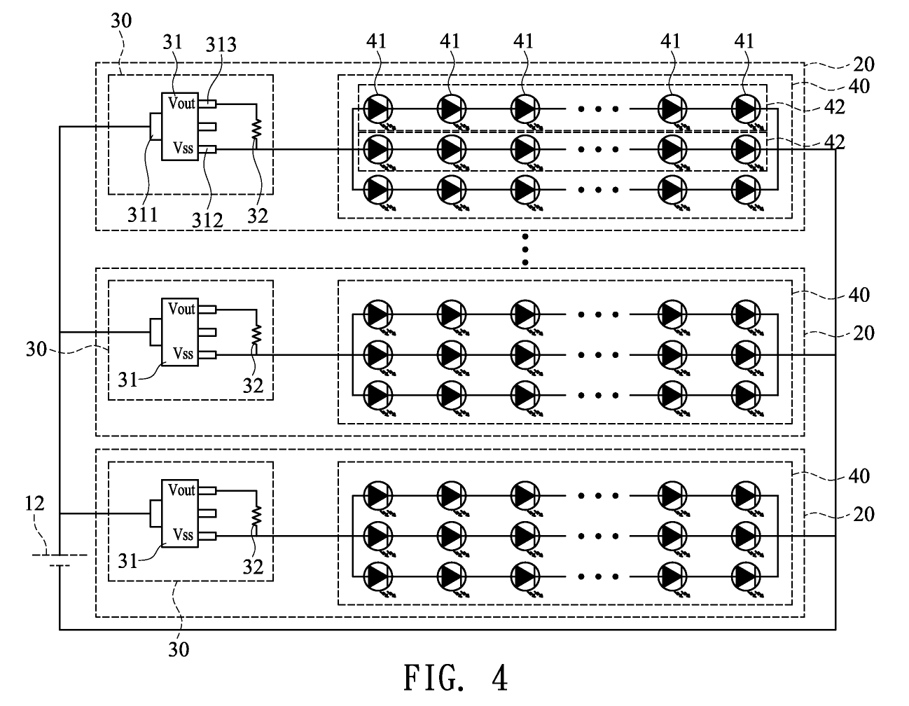

Referring to FIG. 4, alternatively, the LED set 40 comprises a plurality of first LED sets 42 each having LEDs 41 connected in series. The First LED sets 42 are electrically connected to one another in parallel.

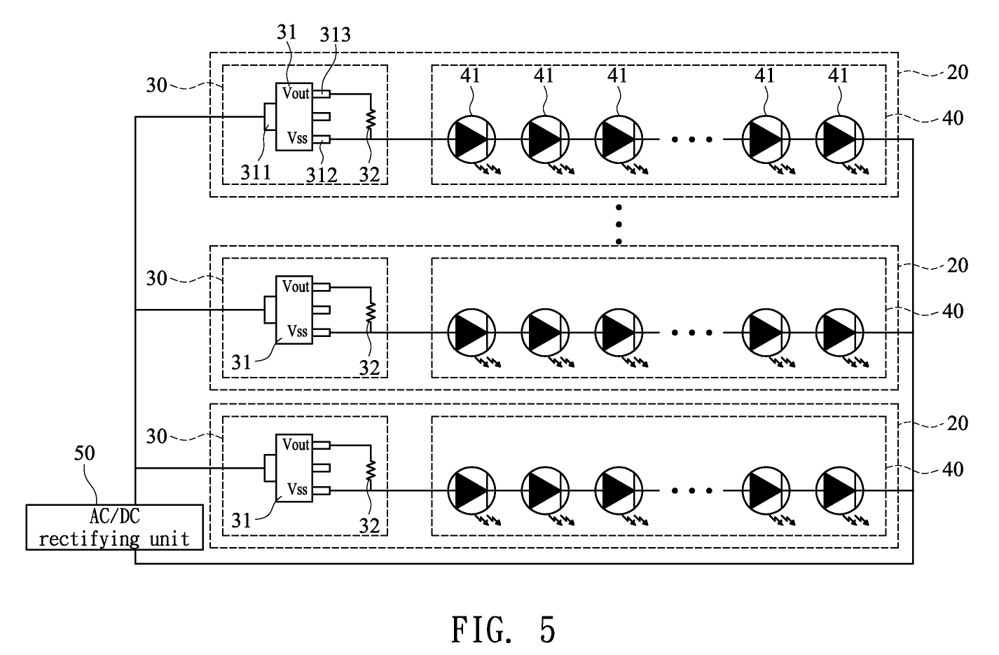

Referring to FIG. 2 through FIG. 4, in general, a DC voltage source 12 directly supplies a DC voltage to drive the LED light source module 20. Referring to FIG. 5, alternatively, to drive the LED light source module 20 from an AC voltage source, the LED light source module 20 further comprises an AC/DC rectifying unit 50 for receiving an AC voltage. The AC/DC rectifying unit 50 converts the AC voltage into the DC voltage, and then the DC voltage is applied to the constant-current unit 30 such that the LED set 40 is powered-on.

Referring to FIG. 2 through FIG. 5, alternatively, a plurality of LED light source modules 20 are connected to one another in parallel. As a result, brightness of the parallelly connected LED light source modules 20 as a whole is enhanced. Also, in case of damage of one of the LED light source modules 20, the constant-current units 30 of unaffected ones of the LED light source modules 20 keep current entering the LED set 40 unchanged and within a range of safe current levels tolerable to the LED set 40. Consequently, the LED set 40 is protected against damage which might otherwise arise from input surge current.

The foregoing preferred embodiments are only illustrative of the features of the present invention but are not intended to restrict the scope of the present invention. The foregoing preferred embodiments allow persons skilled in the art to gain insight into the present invention and therefore be able to implement the present invention. It is apparent to those skilled in the art that all equivalent modifications and variations made in the foregoing preferred embodiments according to the spirit and principle in the disclosure of the present invention should fall within the scope of the appended claims.

What is claimed is:

1. An LED light source module, comprising:
a constant-current unit, comprising:
a voltage stabilizing unit having an input end, a first output end, and a second output end, the input end receiving a DC voltage, and the first output end outputting a constant current; and
a resistor parallel-connected between the first output end and the second output end; and
an LED set electrically connected to the first output end.

2. The LED light source module of claim 1, wherein the LED set comprises a single LED.

3. The LED light source module of claim 1, wherein the LED set comprises a plurality of LEDs connected to one another in series.

4. The LED light source module of claim 1, wherein the LED set comprises a plurality of first LED sets connected to one another in parallel, each said first LED set comprising a plurality of LEDs connected to one another in series.

5. LED light source module of claim 1, further comprising an AC/DC rectifying unit for converting an AC voltage into the DC voltage.

6. A constant-current unit structure for use with an LED light source module, comprising:
a constant-current unit comprising a voltage stabilizing unit having an input end, a first output end, and a second output end, the input end receiving a DC voltage, and the first output end outputting a constant current; and
a resistor parallel-connected between the first output end and the second output end.
